(19) United States
(12) Patent Application Publication
(10) Pub. No.: US 2009/0088489 A1
(43) Pub. Date: Apr. 2, 2009

(54) AMINE CATALYSTS SUITABLE FOR PRODUCING LOW-EMANATION, RECATALYSIS-STABLE FLEXIBLE POLYURETHANE FOAMS

(75) Inventors: Annegret Terheiden, Duisburg (DE); Roland Hubel, Essen (DE); Hans-Heinrich Schloens, Essen (DE); Rudiger Landers, Essen (DE)

Correspondence Address: SCULLY SCOTT MURPHY & PRESSER, PC, 400 GARDEN CITY PLAZA, SUITE 300, GARDEN CITY, NY, 11530, US

(73) Assignee: EVONIK GOLDSCHMIDT GMBH, Essen (DE)

(21) Appl. No.: 12/212,276

(22) Filed: Sep. 17, 2008

(30) Foreign Application Priority Data
Sep. 28, 2007 (DE) 102007046860.3

(51) Int. Cl. C08G 18/16

(52) U.S. Cl. 521/170

(57) ABSTRACT

The present invention relates to the use of a reactive amine catalyst, in particular diethylaminoethoxyethanol and/or diethylethanolamine, in aqueous or organic solutions for producing flexible polyurethane foams having an increased recatalysis stability, and also a catalyst combination containing at least one reactive amine catalyst which can be used according to the invention; and at least one organic potassium, tin, bismuth and/or zinc compound; and/or at least one tertiary amine selected from the group consisting of triethylenediamine, triethylamine and/or silamorpholine; and/or at least one acid-blocked derivative of a tertiary amine.

### FIELD OF THE INVENTION

The invention relates to the use of amine catalysts for producing low-emanation, recatalysis-stable flexible polyurethane foams, a suitable catalyst combination and flexible polyurethane foams produced therefrom.

### BACKGROUND OF THE INVENTION

Flexible polyurethane (PU) foams are used in many technical applications in industry and in the household sector, for example for acoustic insulation, for producing mattresses or for upholstering furniture. A particularly important market for various types of PU foams such as conventional flexible foams based on ether polyol and ester polyol, cold-cure high-resilience foams (HR foams) and rigid foams as well as foams whose properties lie between these classifications is the automobile industry.

Flexible polyurethane foams are usually produced by reacting diisocyanates and polyisocyanates with compounds that contain at least two hydrogen atoms which are reactive towards isocyanate groups, in the presence of blowing agents and customary auxiliaries and additives.

One disadvantage of most PU foams is that volatile organic compounds, for example dimethylformamide (DMF), are emitted. These emanations represent a great quality defect for many fields of use, for example the automobile industry.

Particularly in the case of furniture and mattresses, emanations, for example dimethylformamide (DMF), are a great quality defect or are even hazardous to health when maximum limits are exceeded.

There is therefore an increasing need for low-emanation PU foams.

A substantial source of emanations from PU foams are volatile amine catalysts and impurities such as dimethylformamide that are present therein.

To avoid emanations from PU foams, reactive amine catalysts which are chemically bound in the polyurethane foam have been used in the prior art.

Frequently used reactive amine catalysts have dimethylamino groups. However, a disadvantage of incorporatable compounds available on the market, for example dimethylaminoethoxyethanol, is recatalysis. This causes a deterioration in the mechanical properties of the polyurethane foam over time. In addition, volatile compounds can be formed during recatalysis and these can, in turn, contribute to emanations.

Apart from the disadvantage that such polyurethane foams tend to undergo recatalysis, i.e., destruction of the polyurethane foam occurs, flexible polyurethane foams produced in this way frequently have an unsatisfactory burning behaviour.

### SUMMARY OF THE INVENTION

The present invention provides flexible polyurethane foams which overcome at least one of the above-described disadvantages of the prior art.

Additionally, the present invention also provides amine catalysts for flexible polyurethane foams which have no or a significantly reduced amine emanation, in particular DMF emanation, combined with high catalytic activity to give good foam properties. If amine catalysts which have a dimethylamino group as a structural unit are used for producing flexible polyurethane foams, the resulting foams may emit dimethylformamide in concentrations which are so high that these can lead to eco tests being failed. Dimethylformamide is of toxicological concern since it very probably has teratogenic effects on unborn babies.

Furthermore, the present invention also provides amine catalysts for flexible polyurethane foams which, after heat treatment, lead to no recatalysis or significantly reduced recatalysis compared to amine catalysts having dimethylamino groups in flexible polyurethane foams.

Even more further, the present invention provides amine catalysts for flexible polyurethane foams which give significantly better burning behaviour compared to amine catalysts having dimethylamino groups.

In accordance with the present invention at least one reactive amine catalyst is used in aqueous or organic solutions for producing flexible polyurethane foams, in particular open-celled flexible polyurethane foams, having increased recatalysis stability, wherein the amine catalyst has the following formula:

Z—R—Y (1)

in which
R=polyether radical of the formula (2)

—(R¹—O)ₙ—R²— (2)

with the proviso that n=0-6, or an amine of the formula (3) or (4)

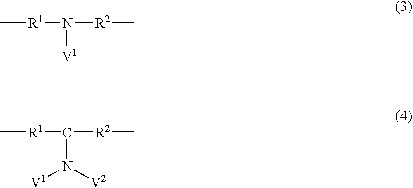

or an amide of the formula (5) or (6)

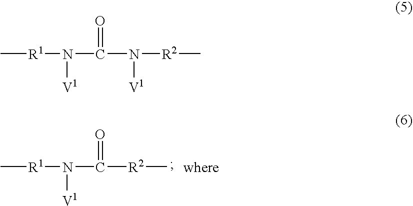

R¹, R² are identical or different and are each a linear, branched or cyclic, aliphatic or aromatic, saturated or unsaturated unsubstituted or heteroatom-substituted hydrocarbon radical having from 2 to 10 carbon atoms,

V¹,V²=—(R¹—O)ₘ—R³ (7)

with the proviso that m=0 to 15 and
R³, R⁴ are identical or different and are each, independently of one another, H or R¹;
Y=H, OH, R, R¹ or an amine radical of the formula (8), (9), (10), (11) or (12)

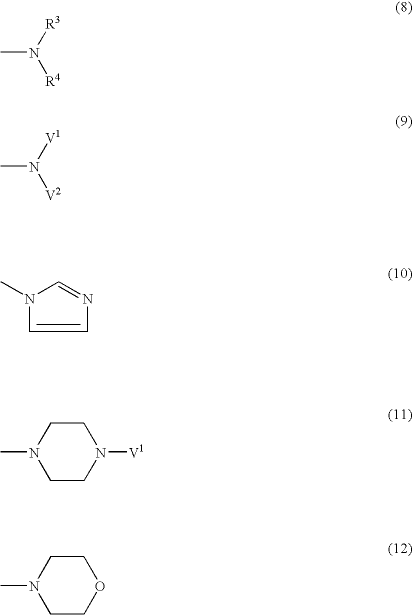

Z=amine radical of one of the above formulae (8), (9), (10), (11), (12) or an amide radical of the formula (13),

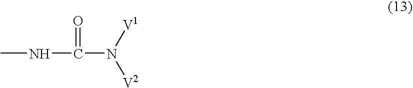

where the amines remaining in the foam have at least one H-acidic group and/or a molecular weight of from ≧200 g/mol to ≦5000 g/mol.

The flexible polyurethane foams produced by means of the amine catalyst according to the invention or by means of a catalyst combination are low in emanations in respect of the amine catalysts used. A particular advantage is that the flexible polyurethane foams produced by means of the amine catalyst according to the invention or by means of a catalyst combination are free of DMF or low in DMF emanations (DMF dimethylformamide).

For the purposes of the present invention, “low-emanation” in respect of dimethylformamide (DMF) denotes that the flexible polyurethane foam has an emanation of DMF from ≧0 μg/m³ to ≦5 μg/m³, preferably ≦1 μg/m³ and particularly preferably ≦0.1 μg/m³, determined by the test chamber method in accordance with DIN 13419-1, 24 hours after loading of the test chamber.

For the purposes of the present invention, “low-emanation” in respect of amine catalysts used denotes that the flexible polyurethane foam has an emanation of amine from ≧0 μg/g to ≦20 μg/g, preferably ≦10 μg/g and particularly preferably ≦5 μg/g, corresponding to the Daimler-Chrysler test method BP VWT709 VOC determination, 30 minutes at 90° C.

The term “amine emanation” does not include the DMF emanation.

### DETAILED DESCRIPTION OF THE INVENTION

As stated above, the present invention relates to the use of amine catalysts for producing low-emanation, recatalysis-stable flexible polyurethane foams, a suitable catalyst combination and flexible polyurethane foams produced therefrom. In particular, the present invention provides a method for producing flexible polyurethane foams, in particular open-celled flexible polyurethane foams, having increased recatalysis stability, wherein the amine catalyst of formula (1) is used in an aqueous or organic solution.

Specifically, the amine catalyst of formula (1) has the following formula:

Z—R—Y (1)

in which
R=polyether radical of the formula (2)

—(R¹—O)ₙ—R²— (2)

with the proviso that n=0-6, or an amine of the formula (3) or (4)

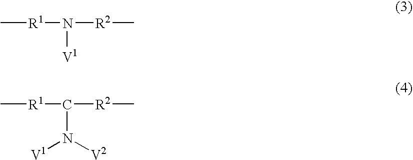

or an amide of the formula (5) or (6)

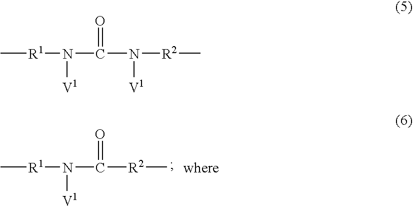

R¹, R² are identical or different and are each a linear, branched or cyclic, aliphatic or aromatic, saturated or unsaturated unsubstituted or heteroatom-substituted hydrocarbon radical having from 2 to 10 carbon atoms,

V¹,V²=—(R¹—O)ₘ—R³ (7)

with the proviso that m=0 to 15 and
R³, R⁴ are identical or different and are each, independently of one another, H or R¹;
Y=H, OH, R, R¹ or an amine radical of the formula (8), (9), (10), (11) or (12)

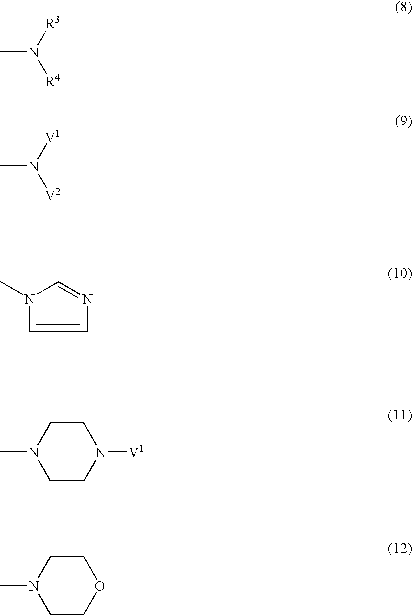

Z=amine radical of one of the above formulae (8), (9), (10), (11), (12) or an amide radical of the formula (13),

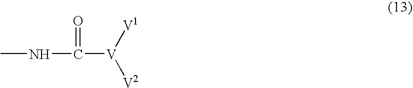

where the amines remaining in the foam have at least one H-acidic group and/or a molecular weight of from ≧200 g/mol to ≦5000 g/mol.

The molecular weight of the amines can also be from ≧300 g/mol to ≦3000 gμmol or from ≧500 g/mol to ≦1000 g/mol, with amine catalysts having a low molecular weight being preferred because of the higher catalysis rate.

A further important feature of the high-resilience flexible foams is the “ball rebound”. A method of determining the ball rebound is described, for example, in ISO 8307. Here, a steel ball having a predetermined mass is allowed to drop onto the test specimen from a particular height and the height of rebound in % of the drop height is then measured. Typical values for a high-resilience flexible foam are in the range ≧55%. In comparison, hot-cure flexible foams or flexible polyurethane ester foams, hereinafter also referred to as ester foams, have ball rebound values of at most 30%-48%.

To produce a high-resilience flexible polyurethane foam, a mixture of polyol, polyfunctional isocyanate, catalyst combination according to the invention, stabilizer, blowing agent (usually water) to form CO₂ and, if appropriate, an addition of physical blowing agents, is reacted, if appropriate with addition of further additives such as flame retardants, colour pastes, fillers, crosslinkers or other customary processing aids.

In the production of high-resilience flexible foam, the critical difference from hot-cure foam is that highly reactive polyols and optionally low molecular weight crosslinkers are used, with the function of the crosslinker also being able to be performed by relatively high-functionality isocyanates. Thus, reaction of the isocyanate groups with the hydroxyl groups occurs even in the expansion phase (CO₂ formation from —NCO and H₂O) of the foam. This rapid polyurethane reaction leads, as a result of the viscosity increase, to a relatively high intrinsic stability of the foam during blowing.

High-resilience flexible polyurethane foams are consequently highly elastic foams in which subsurface stabilization plays a major role. Owing to the high intrinsic stability, the cells are often not sufficiently open at the end of the foaming process and therefore have to be crushed by mechanical means. Here, the necessary opening force is a measure of the proportion of open cells. Foams which have a high proportion of open cells and require only small opening forces are desirable. In the case of foaming in a mould, high-resilience flexible polyurethane foams are, in contrast to hot-cure flexible polyurethane foams, produced at a temperature of, for example, ≦90° C.

Open-celled flexible polyurethane foams have a gas permeability in the range from 1 to 50 mm of water, in particular in the range from 1 to 30 mm of water (determined by measuring the pressure difference on flow through a foam specimen). For this purpose, a 5 cm thick foam sample is placed on a smooth base. A plate (10 cm×10 cm) having a weight of 800 g and a central hole (diameter: 2 cm) and a hose connection is placed on the foam specimen. A constant stream of air of 8 l/min is fed into the foam specimen via the central hole. The pressure difference which occurs (relative to unhindered outflow) is determined by means of a column of water in a graduated pressure meter. The more closed-celled the foam, the greater the pressure which is built up and the more is the surface of the column of water pushed downward and the greater the values which are measured.

Flexible foams are classified not only into high-resilience flexible polyurethane foams and hot-cure flexible polyurethane foams, but also polyurethane ester foams.

Polyurethane ester foams are foams having a very regular cell structure. An irregular structure (known as a sponge structure) can be obtained by a controlled introduction of foam defects. Polyurethane ester foams can be obtained by reaction of diisocyanates with polyesters containing hydroxyl groups, for example, by reaction of dicarboxylic acids and polyhydroxy alcohols. Substances which are suitable for controlled defoaming are, for example, polydimethylsiloxane compounds having a molecular weight of ≧40 000 g/mol. Such polysiloxane compounds which can be used for controlled defoaming have a viscosity of at least 4 000 mPas or above.

According to the invention, it has now been found that the use of the amine catalysts described in formula (1) gives flexible polyurethane foams which have a significantly improved ageing stability than flexible polyurethane foams obtained using dimethylaminoethoxyethanol, i.e., flexible polyurethane foams which have no recatalytic activity or at least significantly reduced recatalytic activity are obtained.

As shown in the examples, the flexible polyurethane foam is completely destroyed after heating at 180° C. for one hour when dimethylaminoethoxyethanol is used. In comparison, the flexible polyurethane foam produced using the amine catalysts of the invention has, depending on the amine catalyst used, a stable flexible polyurethane foam structure.

A further advantage of the amine catalysts according to the invention compared to dimethylaminoethoxyethanol is that at least some of these have, despite longer alkyl chains, a comparable catalytic activity in respect of polyurethane formation and in addition do not promote recatalysis.

Another advantage of the use of the amine catalysts according to the invention is that the resulting flexible polyurethane foam is free of dimethylformamide or virtually free of dimethylformamide.

In a further preferred embodiment of the invention, reactive amines can be used for producing flexible polyurethane foams, wherein the amine catalyst has the formula 14:

R³R⁴N—(R¹—O)ₙR²—Y (14)

where
R¹, R² are identical or different and are each a linear, branched, cyclic or aromatic alkylene radical having from 2 to 8 carbon atoms;
R³, R⁴ are identical or different and are each a linear, branched, cyclic or aromatic hydrocarbon radical having from 2 to 8 carbon atoms;
n is an integer from 0 to 6, preferably from 1 to 4;

### Y=—OH or —NH₂.

These abovementioned reactive amines of the formula R³R⁴N—(R¹—O)ₙR²—Y have a catalytic activity which is greater than that of the other reactive amine catalysts disclosed in the invention and also have no or virtually no recatalysis activity after heating the flexible polyurethane foam produced therewith for one hour at 180° C., with the reactive amine according to the invention remaining chemically bound to the flexible polyurethane foam.

The reactive amine catalysts according to the invention which are mentioned below have, among the abovementioned amine catalysts, a still further-improved catalyst activity and also as good as no recatalysis activity, measured after heating the flexible polyurethane foam produced therewith for one hour at 180° C., with the reactive amine according to the invention remaining chemically bound to the flexible polyurethane foam. These reactive amine catalysts having the further-improved properties have the formula 15:

R³R⁴N—(R¹—O)ₙR²—Y (15)

where
R¹, R² are identical or different and are each a linear alkylene radical having 2, 3 or 4 carbon atoms;

R³, R⁴ are identical or different and are each a linear hydrocarbon radical having 2, 3 or 4 carbon atoms;

n=0, 1, 2 or 3, preferably 1 or 2;

### Y=—OH or —NH₂.

If, for example, diethylaminoethoxyethanol is used in place of dimethylaminoethoxyethanol for producing flexible PU foams, the resulting flexible polyurethane foams have a significantly improved ageing stability. While the flexible polyurethane foam is completely destroyed after heating at 180° C. for one hour when dimethylaminoethoxyethanol is used, the foam produced using diethylaminoethoxyethanol displays no change in the foam structure.

The critical advantage of diethylaminoethoxyethanol over dimethylaminoethoxyethanol is thus that the former is an incorporatable low-emanation amine which has a comparable catalytic activity in respect of polyurethane formation, while not promoting recatalysis.

A further advantage of the use of diethylaminoethoxyethanol is that the resulting flexible polyurethane foam is free of dimethylformamide.

The present invention further provides a catalyst combination for producing flexible polyurethane foams, in particular open-celled flexible polyurethane foams, having increased recatalysis stability, wherein the catalyst combination comprises at least one amine catalyst of formula (1) which can be used according to the invention, and

at least one organic potassium, zinc, bismuth and/or tin compound; and/or at least one tertiary amine selected from the group consisting of triethylenediamine, triethylamine and/or silamorpholine, with silamorpholine being particularly preferred, and with 2,2,4-trimethyl-2-silamorpholine being even more preferred; and/or

at least one acid-blocked derivative of a tertiary amine.

Further preference is given to a catalyst combination comprising:
diethylaminoethoxyethanol and/or diethylethanolamine; and
at least one potassium compound selected from the group consisting of potassium 2-ethylhexanoate and/or potassium acetate, an organic zinc and/or tin compound selected from among salts of octanoic acid, ricinoleic acid, acetic acid, oleic acid, lauric acid and/or hexanoic acid; and/or as chelate complex with acetylacetone, benzoylacetone, trifluoroacetylacetone, ethyl acetoacetate, salicylaldehyde, cyclopentanone-2-carboxylate, salicylaldimine; and/or
at least one tertiary amine selected from the group consisting of triethylenediamine, triethylamine and/or silamorpholine, with silamorpholine being particularly preferred; and/or
at least one acid-blocked derivative of a tertiary amine.

Even greater preference is given to a catalyst combination comprising:
diethylaminoethoxyethanol and/or diethylethanolamine; and
at least one potassium compound selected from the group consisting of potassium 2-ethylhexanoate and/or potassium acetate, an organic zinc and/or tin compound selected from among salts of ricinoleic acid and/or 2-ethylhexanoic acid, preferably tin(II) octoate, zinc(II) octoate, tin ricinoleate and/or zinc ricinoleate; and
at least one tertiary amine selected from the group consisting of triethylenediamine, triethylamine and/or silamorpholine, with particular preference being given to silamorpholine, and with 2,2,4-trimethyl-2-silamorpholine being even more preferred.

The individual components of the catalyst combination can be added either simultaneously or in succession to the isocyanate and polyol reaction mixture.

Preference is here given to the combination of the amine catalysts according to the invention with silamorpholine. Of these various silamorpholines that can be used, 2,2,4-trimethyl-2-silamorpholine is most preferred.

Particular preference is given to the use according to the invention of diethylethanolamine in combination with silamorpholine or of diethylaminoethoxyethanol in combination with silamorpholine as amine catalyst. Greatest preference is given to the use of diethylaminoethoxyethanol rather than diethylethanolamine, since diethylaminoethoxyethanol is even better at preventing recatalysis than is diethylethanolamine.

Some of the amine catalysts used for producing flexible PU foams do not have a specific effect on only one reaction, i.e., they catalyze both the gas evolution reaction (blowing reaction) and the polymer forming reaction (gelling reaction). The degree to which the gas evolution reaction or the crosslinking reaction is catalyzed more strongly depends on the structure of the amine used according to the invention in the particular case. Thus, for example, diethylaminoethoxyethanol catalyzes the blowing reaction more strongly, while the amine silamorpholine catalyzes the crosslinking reaction more strongly. A combination of the two substances thus makes optimal setting/matching of the reaction rate possible. A further advantage of the amine silamorpholine is that, unlike the amines otherwise used for producing flexible foams, it has not only a catalytic activity but also surfactant properties which aid the miscibility of water with the reactants/components/additives.

The silamorpholine content of the catalyst combination can be from 0.5 to 10 percent by weight, preferably from 1 to 8 percent by weight and more preferably from 1.5 to 7 percent by weight, based on the amount of amine catalyst according to the invention.

Particular preference is also given to using triethylenediamine as constituent of the catalyst combination. The individual components can be added simultaneously or in succession to the isocyanate and polyol reaction mixture.

The use of trimethylamine and/or dimethyl-substituted amines can be ruled out according to the invention. The catalyst combination can preferably be free of trimethylamine and/or dimethyl-substituted amines.

The addition of silamorpholine to the amine catalysts and/or catalyst combinations which can be used according to the invention is particularly preferred, since this enables the catalysis rate to be additionally increased without the addition of silamorpholine causing or leading to recatalysis of the flexible polyurethane foam. The individual components can be added simultaneously or in succession to the isocyanate and polyol reaction mixture.

According to the invention, it can be preferred that the catalyst combination is free of methyl-substituted amines.

The use of additional catalysts such as organic metal salts and/or organometallic compounds can in the case of reactive amines promote recatalysis, since both the metal salts and/or organometallic compounds and the reactive amines, insofar as these are at least covalently bound to the flexible polyurethane foam, remain in the open-celled flexible polyurethane foam.

It has now surprisingly been found that the use of a catalyst combination comprising organic salts of the metals potassium, zinc and/or tin and also amine catalysts of the invention significantly promotes the catalysis reaction in the direction of flexible polyurethane foam formation and nevertheless does not promote recatalysis of the flexible polyurethane foam, even after the flexible polyurethane foam produced in this way has been heated at 180° C. for one hour.

In contrast, a catalyst combination of organic salts of the metals potassium, zinc and/or tin with dimethylaminoethoxyethanol leads to complete destruction of the flexible polyurethane foam under otherwise identical conditions.

Particularly suitable amine catalysts for the catalyst combination have been found to be the inventive amine catalysts of the formula 14, with farther improved catalytic activity the amine catalysts of the formula 15 and particularly preferably diethylaminoethoxyethanol.

The potassium compounds which can be used according to the invention can be selected from the group consisting of potassium 2-ethylhexanoate, potassium acetate and mixtures thereof.

The organic zinc and/or tin catalysts which can be used according to the invention and are suitable for the catalyst combination can be selected from the group consisting of metal salts of organic acids and/or the group consisting of chelate complexes.

Possible organic acids are, for example, octanoic acid, ricinoleic acid, acetic acid, oleic acid, lauric acid and hexanoic acid, and possible complexing agents are, for example, acetylacetone, benzoylacetone, trifluoroacetylacetone, ethyl acetoacetate, salicylaldehyde, cyclopentanone-2-carboxylate, salicylaldimine. Particular preference is given to organic zinc and/or tin compounds which are salts of ricinoleic acid and/or 2-ethylhexanoic acid.

In particular, tin compounds or zinc compounds having organic radicals which are completely or partly covalently bound can be preferred.

Preference is given to using tin(II) octoate and/or tin ricinoleate for the catalyst combination.

The use of dibutyltin dilaurate and/or dibutylzinc dilaurate can be ruled out according to the invention.

Particularly good flexible polyurethane foam properties are obtained when a catalyst combination comprising from 0.01 to 3 parts by weight of amine catalyst and from 0.01 to 2 parts by weight of organic potassium, zinc and/or tin compound, based on 100 parts by weight of polyol, is used.

The formulation “polyol” is, for the purposes of the present invention, the polyol or polyol mixture used for producing the respective flexible polyurethane foam.

Good compressive properties, tensile properties, elongation at break properties of the flexible polyurethane foam which are also essentially retained after heat treatment can be achieved by targeted setting of the molar ratios of amine catalyst to the organic potassium, zinc and/or tin compound.

According to the invention, it can therefore be preferred that the catalyst combination comprises the inventive amine catalyst and the organic potassium, zinc and/or tin compound in a molar ratio of from 1:0.05 to 0.05:1, preferably from 1:0.07 to 0.07:1 and more preferably from 1:0.1 to 0.1:1.

The catalyst combination can additionally contain water and a stabilizer, preferably a polyether siloxane, as further components. The individual components can be added simultaneously or in succession to the isocyanate and polyol reaction mixture.

To avoid reaction of the components with one another, in particular between the amine catalyst used according to the invention and the organic potassium, zinc, bismuth and/or tin compound, it can be advantageous to store these components separately from one another and then introduce them simultaneously or in succession into the isocyanate and polyol reaction mixture.

The catalyst combination can additionally contain blowing agents, biocides, antioxidants, buffer substances, surfactants and/or flame retardants.

It goes without saying that in order to produce the different types of flexible polyurethane foam, i.e., hot-cure, high-resilience or ester flexible polyurethane foams, a person skilled in the art will appropriately select the substances such as isocyanate, polyol, stabilizers, surfactant, etc., necessary for this purpose in the particular case in order to obtain the flexible polyurethane foam type desired in the particular case.

A number of patents/patent applications which describe suitable components and processes for producing the various types of flexible polyurethane foam, i.e., hot-cure, high-resilience and ester flexible polyurethane foams, are indicated below and these are fully incorporated by reference.

EP 0152878 A1; EP 0409035 A2; DE 102005050473 A1; DE 19629161 A1; DE 3508292 A1; DE 444-4898 A1; and EP 1061095 A1.

Further information on the starting materials, catalysts and auxiliaries and additives used may be found, for example, in the Kunststoff-Handbuch, Volume 7, Polyurethane, Carl-Hanser-Verlag, Munich, 1^{st} Edition 1966, 2^{nd} Edition 1983 and 3^{rd} Edition 1993.

The compounds, components and additives indicated below are mentioned merely by way of example and can be replaced by other materials known to those skilled in the art.

The flexible polyurethane foams according to the invention can contain surfactants, which will hereinafter also be referred to as “emulsifiers”.

Surfactants used in the production of flexible polyurethane foams can be selected from the group consisting of anionic surfactants, cationic surfactants, non-ionic surfactants and/or amphoteric surfactants.

According to the invention, it is also possible to use polymeric emulsifiers such as polyalkyl polyoxyalkyl polyacrylates, polyvinylpyrrolidones or polyvinyl acetates as surfactants.

As biocides, it is possible to use commercial products such as chlorophen, benzisothiazolinone, hexahydro-1,3,5-tris(hydroxyethyl)-s-triazine, chloromethylisothiazolinone, methylisothiazolinone or 1,6-dihydroxy-2,5-dioxohexane, which are known under the trade names BIT 10, Nipacide BCP, Acticide MBS, Nipacide BK, Nipacide CI, and Nipacide FC.

To produce the flexible polyurethane foams, it is possible to use the processes for producing emulsions which are known to those skilled in the art, e.g., paste processes, homogenization by means of a high-pressure homogenizer, stirring processes, etc., as also described in DE 3024870, which is hereby fully incorporated by reference.

It is frequent practice to mix all components apart from the polyols and isocyanates with one another to form an activator solution before foaming. This then comprises, inter alia, the stabilizers (siloxanes), the catalysts or catalyst combination which can be used according to the invention, the blowing agent, for example water, and any further additives such as flame retardant, colour, biocides, etc., depending on the formulation for the flexible polyurethane foam.

In the case of the blowing agents, a distinction is made between chemical and physical blowing agents. Chemical blowing agents include water whose reaction with the isocyanate groups leads to formation of CO₂. The density of the foam can be controlled by the amount of water added, with preferred amounts of water being in the range from 0.5 to 7.5 parts per 100.0 parts of polyol. Furthermore, as an alternative and/or in addition, it is possible to use physical blowing agents such as carbon dioxide, acetone, hydrocarbons such as n-pentane, isopentane or cyclopentane, cyclohexane, halogenated hydrocarbons such as methylene chloride, tetrafluoroethane, pentafluoropropane, heptafluoropropane, pentafluorobutane, hexafluorobutane and/or dichloromonofluoroethane. The amount of physical blowing agent is preferably in the range from 1 to 20 parts by weight, in particular from 1 to 15 parts by weight, and the amount of water is preferably in the range from 0.5 to 10 parts by weight, in particular from 1 to 5 parts by weight. Among the physical blowing agents, preference is given to carbon dioxide which is preferably used in combination with water as chemical blowing agent.

The activator solution can additionally contain all customary additives known in the prior art for activator solutions. The additives can be selected from the group consisting of flame retardants, UV stabilizers, dyes, biocides, pigments, cell openers, crosslinkers and the like.

To produce a flexible polyurethane foam, a mixture of polyol, polyfunctional isocyanate, amine catalyst, organic potassium, zinc, bismuth and/or tin compound or other metal-containing catalysts, stabilizer, blowing agent, preferably water to form CO₂ and, if necessary, an addition of physical blowing agents, if appropriate with addition of flame retardants, UV stabilizers, colour pastes, biocides, fillers, crosslinkers or other customary processing aids is reacted.

Suitable polyols are ones having at least two H atoms which are reactive toward isocyanate groups; preference is given to using polyether polyols. Such polyols can be prepared by known methods, for example by anionic polymerization of alkylene oxides in the presence of alkali metal hydroxides or alkali metal alkoxides as catalysts and with addition of at least one starter molecule containing from 2 to 3 reactive hydrogen atoms in bound form or by cationic polymerization of alkylene oxides in the presence of Lewis acids such as antimony pentachloride or boron fluoride etherate or by double metal cyanide catalysis. Suitable alkylene oxides have from 2 to 4 carbon atoms in the alkylene radical. Examples are tetrahydrofuran, 1,3-propylene oxide, 1,2- or 2,3-butylene oxide; preference is given to using ethylene oxide and/or 1,2-propylene oxide. The alkylene oxides can be used individually, alternately in succession or as mixtures. Possible starter molecules are water or dihydric and trihydric alcohols such as ethylene glycol, 1,2- and 1,3-propanediol, diethylene glycol, dipropylene glycol, glycerol, trimethylolpropane, etc. Polyfunctional polyols such as sugar can also be used as starters. The polyether polyols, preferably polyoxypropylene-polyoxyethylene polyols, have a functionality of from 2 to 8 and number average molecular weights in the range from 500 to 8000, preferably from 800 to 3500. Further polyols are known to those skilled in the art and can be taken, for example, from EP-A-0 380 993 or U.S. Pat. No. 3,346,557, which are hereby fully incorporated by reference.

To produce moulded and highly elastic flexible foams, preference is given to using bifunctional and/or trifunctional polyether alcohols having primary hydroxyl groups, preferably more than 50%, in particular those having an ethylene oxide block at the end of the chain or those based solely on ethylene oxide.

To produce flexible slabstock foams, preference is given to using bifunctional and/or trifunctional polyether alcohols having secondary hydroxyl groups, preferably more than 90%, in particular those having a propylene oxide block or a random propylene oxide and ethylene oxide block at the end of the chain or those based solely on propylene oxide blocks.

A further class of polyols is filler polyols (polymer polyols). These are characterized in that they contain dispersed solid organic fillers up to a solids content of 40% or more. Use is made of, inter alia:

SAN polyols: These are highly reactive polyols which contain a dispersed copolymer based on styrene-acrylonitrile (SAN).

PHD polyols: These are highly reactive polyols containing polyurea, likewise in dispersed form.

PIPA polyols: These are highly reactive polyols containing a dispersed polyurethane, for example formed by in-situ reaction of an isocyanate with an alkanolamine in a conventional polyol.

The solids content, which depending on the application is preferably in the range from 5 to 40% by weight, based on the polyol, is responsible for improved cell opening, so that the polyol can be foamed, in particular with TDI, in a controlled fashion and no shrinkage of the foams occurs. The solid thus acts as an important processing aid. A further function is to control the hardness via the solids content, since higher solids contents result in a higher hardness of the foam.

The formulations containing solids-containing polyols have a significantly lower intrinsic stability and therefore tend to require not only the chemical stabilization via the crosslinking reaction but also additional physical stabilization.

Depending on the solids content of the polyols, these are used either alone or in admixture with the abovementioned unfilled polyols.

As isocyanates, it is possible to use organic isocyanate compounds containing at least two isocyanate groups. In general, the aliphatic, cycloaliphatic, araliphatic and preferably aromatic polyfunctional isocyanates known per se are employed. Particular preference is given to using isocyanates in an amount of from 60 to 140 mol % relative to the sum of the isocyanate-consuming components.

Specific examples are: alkylene diisocyanates having from 4 to 12 carbon atoms in the alkylene radical, e.g., dodecane 1,12-diisocyanate, 2-ethyltetramethylene 1,4-diisocyanate, 2-methylpentamethylene 1,5-diisocyanate, tetramethylene 1,4-diisocyanate and preferably hexamethylene 1,6-diisocyanate, cycloaliphatic diisocyanates such as cyclohexane 1,3- and 1,4-diisocyanate and also any mixtures of these isomers, 1-isocyanato-3,3,5-trimethyl-5-isocyanatomethylcyclohexane (IPDI), hexahydrotolylene 2,4- and 2,6-diisocyanate and also the corresponding isomer mixtures, dicyclohexylmethane 4,4′-, 2,2′- and 2,4′-diisocyanate and also the corresponding isomer mixtures and preferably aromatic diisocyanates and polyisocyanates such as tolylene 2,4- and 2,6-diisocyanate and the corresponding isomer mixtures, diphenylmethane 4,4′-, 2,4′- and 2,2′-diisocyanate and the corresponding isomer mixtures, mixtures of diphenylmethane 4,4′- and 2,2′-diisocyanates, polyphenylpolymethylene polyisocyanates, mixtures of diphenylmethane 4,4′-, 2,4′- and 2,2′-diisocyanates and polyphenylpolymethylene polyisocyanates (crude MDI) and mixtures of crude MDI and tolylene diisocyanates. The organic diisocyanates and polyisocyanates can be used individually or in the form of their mixtures.

It is also possible to use isocyanates which have been modified by incorporation of urethane, uretdione, isocyanurate, allophanate and other groups, known as modified isocyanates.

Organic polyisocyanates which have been found to be particularly useful and are therefore preferably used are:

tolylene diisocyanate, mixtures of diphenylmethane diisocyanate isomers, mixtures of diphenylmethane diisocyanate and polyphenylpolymethylene polyisocyanate or tolylene diisocyanate with diphenylmethane diisocyanate and/or polyphenylpolymethylene polyisocyanate or prepolymers.

It is possible to use TDI (tolylene 2,4- and 2,6-diisocyanate isomer mixture) and also MDI (diphenylmethane 4,4′-diisocyanate). “Crude MDI” or “polymeric MDI” comprises not only the 4,4′ isomer and the 2,4′- and 2,2′ isomers but also products having more than two rings. The term “pure MDI” refers to two-ring products comprising predominantly 2,4′ and 4,4′ isomer mixtures or prepolymers thereof. Further suitable isocyanates are listed in the patents DE 444898 and EP 1095968, which are hereby fully incorporated by reference.

Stabilizers preferably encompass foam stabilizers based on polydialkylsiloxane-polyoxyalkylene copolymers as are generally used for producing urethane foams. These compounds generally have a structure in which, for example, a long-chain copolymer of ethylene oxide and propylene oxide is joined to a polydimethylsiloxane radical. The linkage between the polydialkylsiloxane and the polyether part can be via an SiC bond or an Si—O—C bond. Structurally, the polyether or the various polyethers can be bound terminally or laterally to the polydialkylsiloxane. The alkyl radical or the various alkyl radicals can be aliphatic, cycloaliphatic or aromatic. Methyl groups are very particularly advantageous. The polydialkylsiloxane can be linear or have branching points. Further foam stabilizers are described in U.S. Pat. Nos. 2,834,748; 2,917,480 and 3,629,308.

Crosslinkers are low molecular weight, polyfunctional compounds which are reactive toward isocyanates. Suitable crosslinkers are hydroxyl- or amine-terminated substances such as glycerol, triethanolamine (TEOA), diethanolamine (DEOA) and trimethylolpropane. They are usually used in concentrations of from 0.5 to 5 parts per 100.0 parts of polyol, depending on the formulation, but can also deviate from these values. When crude MDI is used in foaming in a mould, this likewise performs a crosslinking function. The content of low molecular weight crosslinkers can therefore be reduced correspondingly as the amount of crude MDI increases.

The formulations according to the invention can be used both in slabstock foaming and in foaming in a mould. It is possible to use all processes known to those skilled in the art for producing flexible polyurethane foams. Thus, for example, the foaming process can occur both in a horizontal direction and in a vertical direction in plants operating batchwise or continuously, The stabilizer formulations according to the invention can likewise be used in the CO₂ technique. They can be used in low-pressure and high-pressure machines, in which case the formulations according to the invention can either be metered directly into the mixing chamber or be mixed into one of the components fed into the mixing chamber before this component reaches the mixing chamber. The addition can also be carried out in the raw materials tank.

The present invention further relates to a flexible polyurethane foam produced using the amine catalyst or catalyst combination according to the invention.

The use according to the invention of the catalyst/catalyst combination in the reaction of polyols with isocyanates makes it possible to obtain a flexible polyurethane foam, in particular an open-celled flexible polyurethane foam, having increased recatalysis stability.

As indicated above, customary additives can be added to the reaction mixture for producing the flexible polyurethane foam according to the invention.

According to the invention, it can be preferred that the flexible polyurethane foam is free of methyl-substituted amines.

The flexible polyurethane foam according to the invention can have an emanation of DMF from ≧0 μg/m³ to ≦10 μg/m³, preferably ≦5 μm³, more preferably ≦0.1 μg/m³, and particularly preferably ≦0.1 μg/m³, determined by the test chamber method DIN 13419-1, 24 hours after loading of the test chamber.

The flexible polyurethane foam according to the invention can preferably be free of dimethylformamide. The use according to the invention of the amine catalyst or catalyst combination enables the emanation of DMF from the flexible polyurethane foam to be significantly reduced. Any residual amounts of DMF which can still be detected can be attributed to impurities which cannot be removed without unreasonable effort in the industrial production of the amine catalysts which can be used according to the invention.

Flexible polyurethane foam produced according to the invention is recatalysis stable and has a tensile strength [kPa] of ≧75 after heat treatment at 180° C. for 2 hours.

When, for example, diethylaminoethoxyethanol is used in place of dimethylaminoethoxyethanol for producing flexible polyurethane foams, the resulting foams have a significantly improved ageing stability. While the flexible polyurethane foam is completely destroyed after heating at 180° C. for one hour when dimethylaminoethoxyethanol is used, the flexible polyurethane foam produced using diethylaminoethoxyethanol displays no change.

The critical advantage of diethylaminoethoxyethanol over dimethylaminoethoxyethanol is thus that the former is an incorporatable low-emanation amine which has comparable catalytic activity in respect of polyurethane formation but does not promote recatalysis.

The present invention further provides a product comprising a flexible polyurethane foam according to the invention.

The subject matter of the present invention will be illustrated with the aid of examples.

Production of the Flexible Polyurethane Foams

Foaming was carried out using 300 g of polyol; the other constituents of the formulation were scaled accordingly. Here, for example, 1.0 part of a component means 1 g of this substance per 100 g of polyol.

To carry out foaming, the polyol, water, inventive catalyst combination (=amine catalyst and organic tin compound as in accordance with the invention) and silicone stabilizer were mixed well by stirring. After addition of the isocyanate, the mixture was stirred by means of a stirrer at 3000 rpm for 7 seconds and the mixture was poured into a paper-lined wooden box (base area: 27 cm×27 cm). This gave a foam which was subjected to the use tests described below.

Use Tests

Physical Properties of the Flexible Polyurethane Foams

The flexible polyurethane foams produced were assessed according to the following physical properties:
a) Settling of the foam after the end of the rise phase.
b) Foam density (FD)
c) The air permeability of the foam was determined by measuring the back pressure of the foam. The measured back pressure was reported in mm of water, with lower back pressure values then characterizing the more open foam. The values measured were in the range from 0 to 300 mm.
d) Compression load deflection CLD, 40%
e) Compression set at a compression of 90% for 22 h at 70° C.
f) Ball rebound test
g) Stability after heating at 180° C.
h) Tensile strength
i) Elongation at break

Measurement of the Emanations

Measurement of the VOC Content in Accordance with the Daimler-Chrysler Test Method

The emanation was determined using a method based on the Daimler-Chrysler test method PB VWT 709. The procedure for carrying out the thermal desorption with subsequent coupled gas chromatography/mass spectrometry (GC/MS) is described below.
a) Measurement technique: The thermal desorption was carried out using a thermal desorber “TDS2” with sample changer from Gerstel, Mülheim, in combination with a Hewlett Packard HP6890/HP5973 GC/MSD system.
b) Measurement conditions.

| | |
|---|---|
| Thermal desorption | Gerstel TDS2 |
| Desorption temperature | 90° C. |
| Desorption time | 30 min |
| Flow | 60 ml/min |
| Transfer line | 280° C. |
| Cryofocussing | HP 6890 PTV |
| Liner | Glass vapourizer tube with silanized |
| | glass wool |
| Temperature | −150° C. |

| | |
|---|---|
| GC | Capillary GC HP 6890 |
| Injector | PTV split 1:50 |
| Temperature | −150° C.; 3 min; [symbol] 12° C./s; 280° C. |
| programme | |
| Column | Agilent 19091B-115, Ultra 2, 50 m * 0.32 mm dF 0.5 μm |
| Flow | 1 ml/min const. flow |
| Temperature | 50° C.; 5 min; [symbol] 3° C./min; 92° C.; |
| programme | [symbol] 5° C./min; 160° C.; [symbol] 10° C./min; |
| | 280° C., 20 min |
| Detector | HP MSD 5973 |
| Mode | |
| Evaluation | Evaluation of the total ion current chromatogram by |
| | calculation as toluene equivalent |

c) Calibration
   To carry out the calibration, 1 μl of a mixture of toluene and hexadecane in pentane (each 0.6 mg/ml) was introduced into a cleaned adsorption tube filled with Tenax® TA (mesh 35/60) and measured (desorption: 5 min, 280° C.).
d) Sample preparation
   10 mg of foam in three part samples were introduced into a thermal desorption tube. Care was taken to ensure that the foam was not compressed.

Determination of the Dimethylformamide Emanation by the Chamber Test:

The DMF emanation of the foams obtained was determined at room temperature by a method based on the DIN method DIN 13419-1. The sample was taken after 24 hours. To carry out the test, 2 litres of the test chamber atmosphere were passed at a flow rate of 100 ml/min through an adsorption tube filled with Tenax®TA (mesh 35/60). The procedure for carrying out thermal desorption with subsequent coupled gas chromatography/mass spectrometry (GC/MS) is described below.

Tenax® TA is a porous polymer resin based on 2,6-diphenylene oxide and can be obtained, for example, from Scientific Instrument Services, 1027 Old York Rd., Ringoes, N.J.
e) Measurement technique
   Thermal desorption was carried out using a thermal desorber “TDS2” with sample changer from Gerstel, Mülheim, in combination with a Hewlett Packard HP6890/HP5973 GC/MSD system.
f) Measurement Conditions:

| | |
|---|---|
| Thermal desorption | Gerstel TDS2 |
| Desorption temperature | 280° C. |
| Desorption time | 5 min |
| Flow | 60 ml/min |
| Transfer line | 280° C. |
| Cryofocussing | HP 6890 PTV |
| Liner | Glass vapourizer tube with silanized glass wool |
| Temperature | −150° C. |

| | |
|---|---|
| GC | Capillary GC HP 6890 |
| Temperature | −150° C.; 3 min; [symbol] 12° C./s; 280° C. |
| programme | |
| Column | Agilent 19091B-115, Ultra 2, 50 m * 0.32 mm dF 0.5 μm |
| Flow | 1 ml/min const. flow |
| Temperature | 50° C.; 5 min; [symbol] 3° C./min; 92° C.; |
| programme | [symbol] 5° C./min; 160° C.; |
| | [symbol] 10° C./min; 280° C., 20 min |
| Detector | HP MSD 5973 |
| Evaluation | Evaluation of the total ion current chromatogram by |
| | calculation as toluene equivalent |

g) Calibration
   To carry out the calibration, 1 μl of a mixture of toluene and hexadecane in pentane (each 0.6 mg/ml) was introduced into a cleaned adsorption tube filled with Tenax®TA (mesh 35/60) and measured (desorption: 5 min, 280° C.).

### Foaming Results—Recatalysis

In a formulation based on 4.0 parts of water, the behaviours of dimethylaminoethoxyethanol (TEGOAMIN® DMEE, obtainable from Evonik Goldschmidt GmbH) and diethylaminoethoxyethanol were compared with one another. The amine triethylenediamine, 33% strength solution in dipropylene glycol, (TEGOAMIN® 33, obtainable from Evonik Goldschmidt GmbH) serves as reference. It is known that this amine does not promote recatalysis.

### EXAMPLE 1

Formulation

| | |
|---|---|
| 100 | Parts of polyol*¹ |
| 4.0 | Parts of water |
| 1.0 | Part of foam stabilizer*² |
| | TEGOSTAB ® BF2370 (Evonik |
| | Goldschmidt GmbH) |
| 0.2 | Part of catalyst*³ (Evonik |
| | Goldschmidt GmbH) |
| 48.3 | Parts of isocyanate (tolylene |
| | diisocyanate T80) |
| | (80% of 2,4 isomer, 20% of |
| | 2,6 isomer) |

*¹= Voranol ® CP 3322, obtainable from Dow Chemical; this is a polyether triol having an OH number of 47.
*²= TEGOSTAB ® BF2370, obtainable from Evonik Goldschmidt GmbH; this is a polysiloxane-polyoxyalkylene block copolymer for use as foam stabilizer in the production of slabstock and moulded flexible polyurethane foams.
*³= KOSMOS ® 29, obtainable from Evonik Goldschmidt GmbH; this is the tin(II) salt of ethylhexanoic acid.

The following table shows the type of amine and the foaming result.

| | | | | Compression | |
|---|---|---|---|---|---|
| | | | | load deflection | |
| | Rise | Foam | | CLD, 40% | Tensile |
| | time | density | | compression | strength |
| Amine catalyst | [s] | [kg/m³] | Porosity* | [kPa] | [kPa] |
| 0.15 part of | 89 | 25.3 | 8 | 3.5 | 121 |
| TEGOAMIN ® | | | | | |
| 33 | | | | | |
| 0.15 part | 88 | 25.4 | 8 | 3.6 | 107 |
| (1.13 mmol) of | | | | | |
| TEGOAMIN ® | | | | | |
| DMEE | | | | | |
| 0.182 part | 95 | 25.4 | 9 | 3.6 | 116 |
| (1.13 mmol) of | | | | | |
| diethylamino- | | | | | |
| ethoxyethanol | | | | | |

*= back pressure in mm of water

| | Elongation | Compression | | |
|---|---|---|---|---|
| | at | set | Ball | Nature of |
| | break | 90%, 22 hrs, | rebound | foam after |
| Amine catalyst | [%] | 70° C. [%] | [%] | 1 h at 180° C. |
| 0.15 part of | 199 | −5 | 47 | OK |
| TEGOAMIN ® 33 | | | | |
| 0.15 part | 150 | −6 | 47 | Destroyed |
| (1.13 mmol) of | | | | |
| TEGOAMIN ® | | | | |
| DMEE | | | | |
| 0.182 part | 171 | −6 | 47 | OK |
| (1.13 mmol) of | | | | |
| diethylamino- | | | | |
| ethoxyethanol | | | | |

The critical advantage of the amine diethylaminoethoxyethanol over TEGOAMIN® DMEE is that it does not promote recatalysis.

### EXAMPLE 2

### Foaming Result—Emanation

To examine the influence of the amine catalysts diethylaminoethoxyethanol and dimethylaminoethoxyethanol on the foam emanation, a formulation containing a catalyst combination according to the invention and a low-emanation polyol was selected.

Formulation

| | |
|---|---|
| 100 | Parts of polyol*⁴ |
| 4.0 | Parts of water |
| 1.0 | Part of foam stabilizer*² |
| | (TEGOSTAB ® BF2370*²) |
| 0.54 | Part of catalyst*⁵ (KOSMOS ® EF*⁵) |
| 48.3 | Parts of isocyanate (tolylene |
| | diisocyanate T80) |
| | (80% of 2,4 isomer, |
| | 20% of 2,6 isomer) |
| 0.15 | Part of TEGOAMIN ® DMEE |
| or | |
| 0.182 | Part of diethylaminoethoxyethanol |

*⁴= Arcol 1105S ®, obtainable from Bayer AG; this is a low-emanation polyether triol
*⁵= KOSMOS ® EF, obtainable from Evonik Goldschmidt GmbH; this is tin ricinoleate

The emanation behaviour of the above-described foams was examined in accordance with the Daimler-Chrysler test method BP VWT 709 VOC determination (30 minutes at 90° C.).

This gave the following results.

| | VOC content | |
|---|---|---|
| Amine catalyst | Amine emanation | Total emanation |
| Dimethylaminoethoxyethanol | <1 μg/g | 10 μg/g |
| Diethylaminoethoxyethanol | <1 μg/g | 10 μg/g |

### EXAMPLE 3

### Foaming Result—DMF Emanation

To examine the influence of the amine catalysts diethylaminoethoxyethanol and dimethylaminoethoxyethanol on the emanation of DMF from the foam, a formulation containing a catalyst combination according to the invention and a low-emanation polyol was selected.

Formulation

| | |
|---|---|
| 100 | Parts of polyol*⁴ |
| 2.5 | Parts of water |
| 0.8 | Part of foam stabilizer*² |
| | (TEGOSTAB ® BF2370*²) |
| 0.42 | Part of catalyst*⁵ (KOSMOS ® EF*⁵) |
| 34.0 | Parts of isocyanate (tolylene diisocyanate |
| | T80) |
| | (80% of 2,4 isomer, |
| | 20% of 2,6 isomer) |
| 0.50 | Part of (TEGOAMIN ® DMEE) |
| or | |
| 0.61 | Part of diethylaminoethoxyethanol |

*⁴= Arcol 1105S ®, obtainable from Bayer AG; this is a low-emanation polyether triol
*⁵= KOSMOS ® EF, obtainable from Evonik Goldschmidt GmbH; this is tin ricinoleate

The emanation of DMF from the above-described foams was examined by the test chamber method using a procedure based on DIN 13419-1.

Samples were taken after 24 hours, and the following results were obtained:

DMF emanation by the test chamber method:

| | DMF emanation, 24 h after |
|---|---|
| Amine catalyst | loading of the test chamber |
| Dimethylaminoethoxyethanol | 7 μg/m³ |
| Diethylaminoethoxyethanol | <0.1 μg/m³ |

### EXAMPLE 4

In a formulation based on 4.0 parts of water, the behaviours of dimethylaminoethoxyethanol (TEGOAMIN® DMEE, obtainable from Evonik Goldschmidt GmbH) and diethylaminoethoxyethanol were compared with one another. The amine TEGOAMIN® 33 (obtainable from Evonik Goldschmidt GmbH) serves as reference. It is known that this amine does not promote recatalysis.

Formulation

| | |
|---|---|
| 100 | Parts of polyol*¹, Voranol ® CP 3322 (Dow |
| | Chemical) |
| 4.0 | Parts of water |
| 1.0 | Part of foam stabilizer*² TEGOSTAB ® BF2370 |
| | (Evonik Goldschmidt GmbH) |
| 0.2 | Part of KOSMOS ® 29*³ (Evonik Goldschmidt |
| or | GmbH) or |
| 0.54 | Part of KOSMOS ® EF*⁵ |
| 48.3 | Parts of isocyanate (tolylene diisocyanate T80) |
| | (80% of 2,4 isomer, 20% of 2,6 isomer) |

To examine the effect of recatalysis, the foams are examined firstly without any after-treatment after they have been produced and secondly after heating at 180° C. for 30 minutes, 60 minutes and 120 minutes. The following tables show the type of amine and the foaming results.

| | | | | CLD, 40% compression | | | |
|---|---|---|---|---|---|---|---|
| | | | | [kPa] | | | |
| | | | | | | after | after |
| | Rise | Foam | | | after 30 min | 1 h | 2 h |
| | time | density | | | at | at | at |
| Catalysts | [s] | [kg/m3] | Porosity* | RT | 180° C. | 180° C. | 180° C. |
| 0.15 part of | 93 | 25.1 | 10 | 3.2 | 2.7 | 2.7 | 2.5 |
| TEGOAMIN ® 33 | | | | | | | |
| 0.20 part of KOSMOS ® 29*³ | | | | | | | |
| 0.15 part (1.13 mmol) of | 96 | 25.0 | 7 | 3.2 | 2.1 | 0.4 | 0.3 |
| TEGOAMIN ® DMEE | | | | | | | |
| 0.20 part of KOSMOS ® 29*³ | | | | | | | |
| 0.182 part (1.13 mmol) of | 98 | 25.2 | 9 | 3.5 | 2.9 | 2.2 | 1.7 |
| diethylaminoethoxyethanol | | | | | | | |
| 0.20 part of KOSMOS ® 29*³ | | | | | | | |
| 0.15 part (1.13 mmol) of | 86 | 24.6 | 8 | 3.2 | 1.9. | 0.5 | 0.5 |
| TEGOAMIN ® DMEE | | | | | | | |
| 0.54 part of KOSMOS ® EF*⁵ | | | | | | | |
| 0.182 part (1.13 mmol) | 86 | 24.5 | 8 | 3.2 | 2.7 | 2.0 | 1.5 |
| of diethylaminoethoxyethanol | | | | | | | |
| 0.54 part of KOSMOS ® EF*⁵ | | | | | | | |

RT = room temperature 23° C. without heating.
*= back pressure in mm of water

| | Compression set 22 hrs, 90% | | | |
|---|---|---|---|---|
| | compression, 70° C. [%] | | | |
| | | after 30 | after | |
| | without | min at | 1 hr at | after 2 h at |
| Catalysts | heating | 180° C. | 180° C. | 180° C. |
| 0.15 part of TEGOAMIN ® | −6 | −7 | −7 | −10 |
| 33 | | | | |
| 0.20 part of KOSMOS ® | | | | |
| 29*³ | | | | |
| 0.15 part (1.13 mmol) of | −6 | −9 | −67 | −82 |
| TEGOAMIN ® DMEE | | | | |
| 0.20 part of KOSMOS ® | | | | |
| 29*³ | | | | |
| 0.182 part (1.13 mmol) of | −6 | −8 | −8 | −12 |
| diethylaminoethoxyethanol | | | | |
| 0.20 part of KOSMOS ® | | | | |
| 29*³ | | | | |
| 0.15 part (1.13 mmol) of | −6 | −10 | −66 | −84 |
| TEGOAMIN ® DMEE | | | | |
| 0.54 part of KOSMOS ® | | | | |
| EF*⁵ | | | | |
| 0.182 part (1.13 mmol) of | −8 | −8 | −9 | −10 |
| diethylaminoethoxyethanol | | | | |
| 0.54 part of KOSMOS ® | | | | |
| EF*⁵ | | | | |

| | Tensile strength | | | |
|---|---|---|---|---|
| | [kPa] | | | |
| | | after | after | |
| | without | 30 min | 1 h at | after 2 h at |
| Catalysts | heating | at 180° C. | 180° C. | 180° C. |
| 0.15 part of TEGOAMIN ® | 105 | 113 | 110 | 104 |
| 33 | | | | |
| 0.20 part of KOSMOS ® | | | | |
| 29*³ | | | | |
| 0.15 part (1.13 mmol) of | 94 | 76 | 14 | 15 |
| TEGOAMIN ® DMEE | | | | |
| 0.20 part of KOSMOS ® | | | | |
| 29*³ | | | | |
| 0.182 part (1.13 mmol) of | 91 | 118 | 104 | 78 |
| diethylaminoethoxyethanol | | | | |
| 0.20 part of KOSMOS ® | | | | |
| 29*³ | | | | |
| 0.15 part (1.13 mmol) of | 94 | 59 | 24 | 19 |
| TEGOAMIN ® DMEE | | | | |
| 0.54 part of KOSMOS ® | | | | |
| EF*⁵ | | | | |
| 0.182 part (1.13 mmol) of | 98 | 105 | 104 | 84 |
| diethylaminoethoxyethanol | | | | |
| 0.54 part of KOSMOS ® | | | | |
| EF*⁵ | | | | |

| | Elongation at break [%] | | | |
|---|---|---|---|---|
| | | after | after | |
| | without | 30 min | 1 h at | after 2 h at |
| Catalysts | heating | at 180° C. | 180° C. | 180° C. |
| 0.15 part of TEGOAMIN ® | 181 | 219 | 240 | 249 |
| 33 | | | | |
| 0.20 part of KOSMOS ® | | | | |
| 29*³ | | | | |
| 0.15 part (1.13 mmol) of | 150 | 199 | 13 | 15 |
| TEGOAMIN ® DMEE | | | | |
| 0.20 part of KOSMOS ® | | | | |
| 29*³ | | | | |
| 0.182 part (1.13 mmol) of | 130 | 179 | 233 | 164 |
| diethylaminoethoxyethanol | | | | |
| 0.20 part of KOSMOS ® | | | | |
| 29*³ | | | | |
| 0.15 part (1.13 mmol) of | 171 | 141 | 66 | 14 |
| TEGOAMIN ® DMEE | | | | |
| 0.54 part of KOSMOS ® | | | | |
| EF*⁵ | | | | |
| 0.182 part (1.13 mmol) of | 168 | 227 | 224 | 195 |
| diethylaminoethoxyethanol | | | | |
| 0.54 part of KOSMOS ® | | | | |
| EF*⁵ | | | | |

| | Ball rebound [%] | | | |
|---|---|---|---|---|
| | | after | after | |
| | without | 30 min | 1 h at | after 2 h at |
| Catalysts | heating | at 180° C. | 180° C. | 180° C. |
| 0.15 part of TEGOAMIN ® | 46 | 47 | 46 | 45 |
| 33 | | | | |
| 0.20 part of KOSMOS ® | | | | |
| 29*³ | | | | |
| 0.15 part (1.13 mmol) of | 46 | 42 | 16 | 5 |
| TEGOAMIN ® DMEE | | | | |
| 0.20 part of KOSMOS ® | | | | |
| 29*³ | | | | |
| 0.182 part (1.13 mmol) of | 46 | 46 | 42 | 38 |
| diethylaminoethoxyethanol | | | | |
| 0.20 part of KOSMOS ® | | | | |
| 29*³ | | | | |
| 0.15 part (1.13 mmol) of | 46 | 40 | 10 | 0 |
| TEGOAMIN ® DMEE | | | | |
| 0.54 part of KOSMOS ® | | | | |
| EF*⁵ | | | | |
| 0.182 part (1.13 mmol) of | 46 | 45 | 42 | 30 |
| diethylaminoethoxyethanol | | | | |
| 0.54 part of KOSMOS ® | | | | |
| EF*⁵ | | | | |

The substantial advantage of the amine diethylaminoethoxyethanol over TEGOAMIN® DMEE is that it virtually does not promote recatalysis. Thus, the foams produced using diethylaminoethoxyethanol have physical properties even after heating at 180° C. for one hour which are comparable to those of the untreated foam. In the case of foams produced using DMEE, the other physical properties such as tensile strength, elongation at break, ball rebound and compression set undergo drastic changes after heating at 180° C. for one hour.

### EXAMPLE 5

### Burning Behaviour

In a formulation based on 4.0 parts of water, the influence of dimethylethanolamine (TEGOAMIN® DMEA) and diethylethanolamine (DEEA) on the burning behaviour of the PU foams were compared with one another.

Formulation

| | |
|---|---|
| 100 | Parts of polyol, Voranol ® CP 3322*¹ (Dow |
| | Chemical) |
| 4.0 | Parts of water |
| 0.8 | Part of foam stabilizer |
| | TEGOSTAB ® B8239*⁶ (Evonik Goldschmidt |
| | GmbH) |
| 0.2 | Part of KOSMOS ® 29*³ (Evonik |
| | Goldschmidt GmbH) |
| 50.6 | Parts of isocyanate (tolylene diisocyanate T80) |
| | (80% of 2,4 isomer, 20% of 2,6 isomer) |

*⁶= TEGOSTAB ® B8239, obtainable from Evonik Goldschmidt GmbH; this is a polyether siloxane

To examine the burning behaviour, the foams produced are subjected to the burning test UL94. The following table shows the type of amine and the burning results.

| | Rise | Foam | | Burning behaviour |
|---|---|---|---|---|
| | time | density | | UL94 Burning rate |
| Catalysts | [s] | [kg/m³] | Porosity* | [mm/min] |
| part of | 114 | 25.2 | 16 | 85 |
| DMEA | | | | |
| 8.0 parts of | | | | |
| Fyrol A-300 TB*⁷ | | | | |
| part of | 117 | 25.7 | 14 | 88 |
| DMEA | | | | |
| 10.0 parts of | | | | |
| Fyrol A-300 TB*⁷ | | | | |
| 0.1315 part of DEEA | 117 | 25.2 | 22 | 75 |
| 8.0 parts of | | | | |
| Fyrol A-300 TB*⁷ | | | | |
| 0.1315 part of DEEA | 121 | 25.6 | 21 | 84 |
| 10.0 parts of | | | | |
| Fyrol A-300 TB*⁷ | | | | |

*= back pressure in mm of water
*⁷= Fyrol A-300 TB, obtainable from Akzo Nobel Chemicals GmbH; this is a mixture of phosphate ester with tris(1,3-dichloroisopropyl) phosphate CAS number 13674-87-8; EC number 237-159-2

The test specimen is fixed in a horizontal position and a Bunsen burner flame is applied to it for 15 s.

Using the 4.0 parts of water formulation, it was able to be shown that the foams produced using DEEA (diethylethanolamine) display an improved burning behaviour compared to TEGOAMIN® DMEA.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

What is claimed is:

1. A method of producing a flexible polyurethane foam having increased recatalysis stability, said method comprising reacting at least a polyol and an isocynate in the presence of an amine catalyst having the following formula in which:
Z—R—Y (1)
R=polyether radical of the formula (2)
—(R¹—O)ₙ—R²— (2)
with the proviso that n=0-6,
or an amine of the formula (3) or (4) 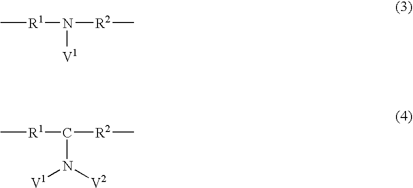
or an amide of the formula (5) or (6) 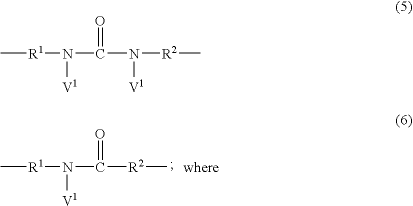
R¹, R² are identical or different and are each a linear, branched or cyclic, aliphatic or aromatic, saturated or unsaturated unsubstituted or heteroatom-substituted hydrocarbon radical having from 2 to 10 carbon atoms,
V¹,V²═—(R¹—O)ₘ—R³ (7)
with the proviso that m=0 to 15 and
R³, R⁴ are identical or different and are each, independently of one another, H or R¹;
Y=H, OH, R, R¹ or an amine radical of the formula (8), (9), (10), (11) or (12) 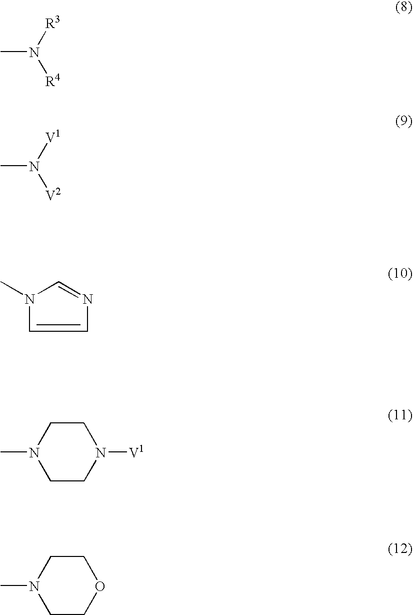
Z=amine radical of one of the above formulae (8), (9), (10), (11), (12) or an amide radical of the formula (13), 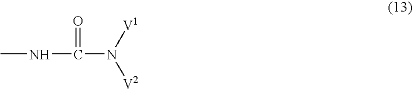
where the amines remaining in the foam have at least one H-acidic group and/or a molecular weight of from ≧200 g/mol to ≦5000 g/mol.

2. The method of claim 1 wherein said amine catalyst has the following formula:
R³R⁴N—(R¹—O)ₙR²—Y
where
R¹, R² are identical or different and are each a linear, branched, cyclic or aromatic alkylene radical having from 2 to 8 carbon atoms;
R³, R⁴ are identical or different and are each a linear, branched, cyclic or aromatic hydrocarbon radical having from 2 to 8 carbon atoms;
n is an integer from 0 to 6, preferably from 1 to 4; and
Y=OH or —NH₂.

3. The method of claim 1 wherein the amine catalyst has the following formula:
R³R⁴N—(R¹—O)ₙR²—Y
where
R¹, R² are identical or different and are each a linear alkylene radical having 2, 3 or 4 carbon atoms;
R³, R⁴ are identical or different and are each a linear hydrocarbon radical having 2, 3 or 4 carbon atoms;
n=0, 1, 2 or 3, preferably 1 or 2;
Y=—OH or —NH₂.

4. The method of claim 1 wherein said amine catalyst comprises diethylamino-ethoxyethanol, diethylethanolamine or mixtures thereof.

5. The method of claim 1 wherein said amine catalyst is used in a catalyst combination with at least one of the following:
at least one organic potassium, zinc, bismuth and/or tin compound;
at least one tertiary amine selected from the group consisting of triethylenediamine, triethylamine and silamorpholine; and
at least one acid-blocked derivative of a tertiary amine.

6. The method of claim 5 wherein the potassium compound is selected from the group consisting of potassium 2-ethylhexanoate, potassium acetate and mixtures thereof; the organic zinc and/or tin compound is selected from the group consisting of metal salts of organic acids, chelate complexes, and mixtures thereof.

7. The method of claim 5 wherein the catalyst combination comprises from 0.01 to 3 parts by weight of amine catalyst and from 0.01 to 2 parts by weight of organic potassium, zinc and/or tin compound, based on 100 parts by weight of polyol.

8. The method of claim 5 wherein the catalyst combination comprises the amine catalyst and the organic potassium, zinc or tin compound in a molar ratio of from 1:0.05 to 0.05:1.

9. The method of claim 5 wherein the catalyst combination further includes water and a stabilizer.

10. The method of claim 5 wherein the catalyst combination further includes at least one of a blowing agent, a biocide, an antioxidant, a buffer substance, a surfactant and a flame retardant.

11. The method of claim 5 wherein the catalyst combination includes 2,2,4-trimethyl-2-silamorpholine as said tertiary amine.

12. The method of claim 1 wherein said flexible polyurethane foam formed has an emanation of DMF from ≧0 μg/m³ to ≦10 μg/m³.

13. The method of claim 1 wherein said flexible polyurethane foam formed has an emanation of amine from ≧0 μg/g to ≦20 μg/g.

14. The method of claim 1 wherein said flexible polyurethane foam formed has a tensile strength [kpa] of ≧75 after heat treatment at 180° C. for 2 hours.

15. A product comprising a flexible polyurethane foam having an emanation of DMF from ≧0 μg/m³ to ≦5 μg/m³.

16. A product comprising a flexible polyurethane foam having an emanation of amine from ≧0 μg/g to ≦20 μg/g.

17. A product comprising a flexible polyurethane foam having a tensile strength [kPa] of ≧75 after heat treatment at 180° C. for 2 hours.
